(19) United States
(12) Patent Application Publication
(10) Pub. No.: US 2008/0211621 A1
(43) Pub. Date: Sep. 4, 2008

(54) Electronic Communication System, in Particular Authentication Control System, as Well as Corresponding Method

(75) Inventors: Juergen Nowottnick, Hamburg (DE); Soeren Soerensen, Hamburg (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/915,185

(22) PCT Filed: May 22, 2006
(86) PCT No.: PCT/IB2006/051618

§ 371 Date: Nov. 21, 2007

(30) Foreign Application Priority Data
May 23, 2005 (EP) 05104341.2

(51) Int. Cl. G06K 19/00; G06K 19/07

(52) U.S. Cl. 340/5.2; 235/375; 340/286.01; 340/5.8; 455/39

(57) ABSTRACT

In order to provide an electronic communication system (100), having at least one base station (10) with at least one antenna unit (16), in particular in coil form; and at least one transponder station (40), in particular in data carrier form, with at least one antenna unit (32), in particular in coil form, for receiving electromagnetic radiation (26) in form of power to be supplied by the base station (10) with a particular carrier frequency and for exchanging data signals (22, 24) with the base station (10), wherein the receiving frequency (f) can be adapted, in particular optimized, during operation, it is proposed that the electronic communication system (100) comprises at least one controller unit (36) for controlling the receiving frequency (f) of the antenna unit (32) of the transponder station (40) during operation of the communication system (100), in particular for adapting the resonant frequency of the antenna unit (32) of the transponder station (40) to the carrier frequency defined by the base station (10).

The present invention relates in general to the technical field of security systems and/or of access systems, and in particular to the technical field of transponder systems.

More specifically, the present invention relates to an electronic communication system as detailed in the preamble of claim 1 and to a communication method as detailed in the preamble of claim 7.

In the following, the state of the art is exemplified by means of a passive transponder being used for example for electronic immobilizers or for electronic anti-theft devices.

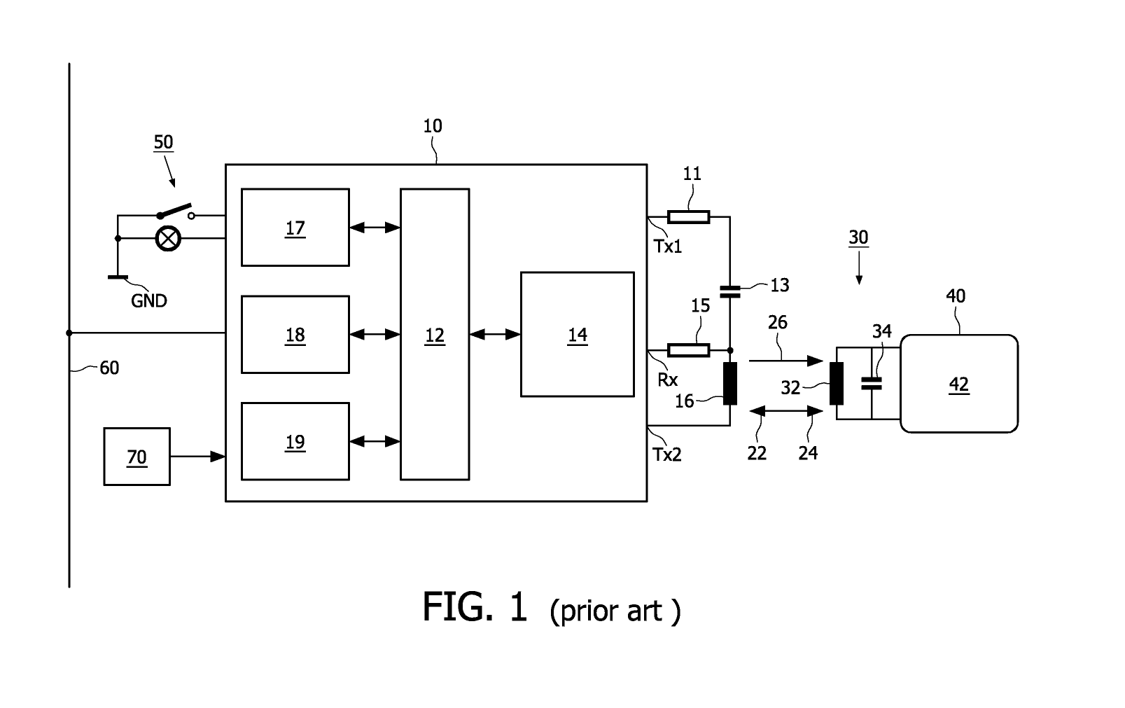

To provide electronic communication systems, and in particular transponder systems, of the kind specified above having among other things a conventional passive transponder system, use is conventionally made of various configurations. One possible configuration is shown in FIG. 1, the example used being that of a transponder system:

Between a so-called base station 10 being fitted with an antenna unit 16 in the form of a coil and a transponder station 40 being also fitted with an antenna unit 32 in the form of a coil, a communication sequence in the form of exchange of data 22, 24 takes place.

In detail, there are, as signal transmission links between the base station 10 and the transponder station 40,
a so-called down-link frame 24 which is formed, for example, by at least one inductively coupled L[ow]F[requency] channel and over which signals are transmitted from the base station 10 to the transponder station 40, and
a so-called up-link frame 22 which is formed, for example, by at least one L[ow]F[requency] channel and over which signals are transmitted from the transponder station 40 to the base station 10.

Thus, both the down-link frame 24 and the up-link frame 22 each are formed by at least one L[ow]F[requency] channel; thus, the electronic communication system, in particular the passive transponder system, works with L[ow]F[requency]/L[ow]F[requency] data as well as with L[ow]F[requency] energy transmission.

After, for example, a pushbutton in the motor vehicle has been operated, the base station 10, which is spatially and functionally associated with the motor vehicle, begins to generate a signal being referred to as a “challenge” and being transmitted to the transponder station 40 via the down-link frame 24.

An integrated circuit 42 in the transponder station 40, which is preferably equipped with at least one microprocessor, then calculates from the challenge, using a cryptographic algorithm and a secret key, a signal sequence being referred to as a “response”. This response signal is then transmitted from the transponder station 40 to the base station 10 via the up-link frame 22.

The base station 10 then compares the response, using an identical crypto-algorithm and an identical secret key. If identity is found, the base station 10 causes the door lock of the motor vehicle to open, i.e. only if, generally by using cryptographic methods, the authentication process recognizes the transponder station 40 as valid, the door lock of the motor vehicle is opened.

The transponder station 40 is supplied with energy by the base station 10 via a transmission link 26 by which electromagnetic radiation in form of power, for instance with a carrier frequency of 125 Kilohertz, is transmitted from the base station 10 to the remote device 40.

The transponder station 40 comprises no battery or the like. The oscillator circuit 30 of the transponder station 40 transforms the induced voltage with a quality factor Q of its own oscillation performance. The oscillation performance in turn is strongly dependent on the detuning of the oscillation circuit 30.

If it is intended to use components with high tolerances, what is usually done for reasons of costs, a reduction of the effective performance and thereby a reduction of the communication range occurs being usually the delimiting factor of a transponder system. For this reason, weakly coupled conventional transponder systems are feasible only with relatively high expenses. However, high expenses are not acceptable in mass production.

Regarding this problem, prior art documents JP 06291755 A and U.S. Pat. No. 5,698,838 propose to use an electrically controlled resistor to control the quality factor of the oscillation performance of a resonant circuit in order to keep the amplitude of the output constant. In more detail, for controlling the quality factor (performance) of the oscillation circuit a F[ield]E[ffect]T[ransistor] is connected in parallel to the oscillation circuit. However, this way of controlling the quality factor of the oscillation performance is not easy to realize and cannot be implemented on a low-price level.

Moreover, prior art document US 2004/0065733 A1 discloses the switching of capacitors to tune a resonant circuit based on the amplitude of the received signal. Therefor, an arrangement comprising a capacitive element and a F[ield]E[ffect]T[ransistor] is proposed. However, the FET is not operated as a linearly controllable resistor, but the FET is switched. The proposal of prior art document US 2004/0065733 A1 intends to set up a constant resonance frequency during anti-collision, i.e. if other tags are nearby and put the antenna out-of-tune.

According to the prior art, the receiving frequency is calibrated or trimmed once during production of the transponder station 40 for optimizing the electrical transmission between the base station 10 and the transponder station 40. These calibration data are stored in an electrically erasable and programmable read-only-memory (EEPROM), and these calibrated transponder stations 40 are used in online-operation. Thus, the capacities, being mostly dually scaled, are switched. Consequently, according to the prior art merely the initial tolerances (during production) are adapted but neither processes of aging nor the dependency on temperature dependency are taken into account.

Starting from the disadvantages and shortcomings as described above and taking the prior art as discussed into account, an object of the present invention is to further develop an electronic communication system of the kind as described in the technical field, as well as a communication method of the kind as described in the technical field in such way that the receiving frequency can be adapted, in particular optimized, during operation.

The object of the present invention is achieved by an electronic communication system comprising the features of claim 1, as well as by a communication method comprising the features of claim 7. Advantageous embodiments and expedient improvements of the present invention are disclosed in the respective dependent claims.

The present invention is based on the idea of controlling the receiving frequency, in particular the resonant frequency, of the transponder tank circuit according to any control method, in particular of making the receiving frequency or the resonant frequency of the transponder tank circuit at least nearly equal to the carrier frequency (optimum).

Thus, the present invention enables the usage of cost-efficient oscillator circuit components, such as
at least one antenna unit, in particular at least one inductive element, and/or
at least one capacitive element, in particular at least one condenser unit,

in the tag or transponder station wherein expediently relatively few additional chip space in the tag or transponder station is required. Therefore, the present invention leads to the advantage that the overall system costs are reduced because components with higher tolerances may be applied.

The present invention achieves an optimal electrical transmission between the base station, for example operating as a sending unit, and the transponder station, for example operating as a receiving unit, in spite of relatively high spread of the characteristic values of the implemented components, wherein said spread leads to a distribution of the receiving frequency, in particular of the resonance frequency, of the single tag units, in particular of the transponder stations.

The electrical transmission or energy transfer is optimal under operating conditions if said electrical transmission or energy transfer is substantially performed at the receiving frequency of the circuit arrangement of the transponder tag. In order to realize such optimal electrical transmission or energy transfer, according to the teaching of the present invention the receiving frequency of the antenna unit of the transponder station is controlled during operation of the communication system, in particular the resonant frequency of the antenna unit of the transponder station is adapted to the carrier frequency defined by the base station.

Thus, the present invention leads to the advantage that optimal conditions for energy transfer as well as for data transmission are provided and thereby the communication range is maximized.

The controlling of the receiving frequency during operation of the communication system leads to the advantage that any influences of production, of aging and/or of temperature can be compensated.

Moreover, according to a preferred embodiment of the present invention, the receiving frequency can be controlled in a continuous and/or linear and/or steady mode, which saves chip space.

Independently thereof or in combination therewith the receiving frequency is adapted to the carrier frequency in such a way that the receiving frequency substantially or approximately equals the carrier frequency.

To control the receiving frequency, in particular the resonant frequency, of the circuit arrangement, in particular of the receiving oscillator circuit, for example of the resonant LC circuit, to the optimum, according to a preferred embodiment of the present invention, a combination of
at least one capacitive element, being in particular connected in parallel to the antenna unit of the transponder station, and
at least one resistor element, being in particular connected in parallel to the capacitive element and/or to the antenna unit of the transponder station,

is connected to the circuit arrangement of the transponder station, wherein the resistance value of said resistor element is controllable by the controller unit.

Thus, according to a preferred embodiment the present invention describes a way to control the resonant frequency of a parallel resonant circuit, for instance applied in passive transponder circuits; in this context, the term “passive” may mean that the transponder circuit or transponder system or transponder unit does not comprise any battery.

For controlling the receiving frequency, in particular the resonant frequency, of the transponder station the present invention proposes the following advantageous embodiments:
optimum control, in particular linear steady control, of the resonance frequency of a series resonant circuit, in particular of an LC tank circuit, via at least one controllable RC member, in particular through at least one series RC circuit, comprising
at least one further capacitive element and
at least one, in particular electrically, controllable resistor,

in parallel with the inductive element of the transponder station, in particular in parallel to the tank circuit; or
optimum control, in particular linear steady control, of the resonance frequency of a series resonant circuit, in particular of an LC tank circuit, via at least one controllable RL member, in particular through at least one series RL circuit, comprising
at least one further inductive element and
at least one, in particular electrically, controllable resistor,

in parallel with the inductive element of the transponder station, in particular in parallel to the tank circuit.

These advantageous embodiments can be realized in an easy and cost-effective way.

According to the teaching of the present invention, the control unit enables
an adaptive control of the receiving frequency, in particular of the resonant frequency, and/or
a control to the maximal voltage at the oscillator circuit and/or
an adjustment of the receiving frequency, in particular of the resonant frequency, by phase control.

A further advantage of these embodiments is that chip integration is increased because the control structures can optionally be integrated on the integrated circuit of the transponder tag; alternatively, the control structures can be separately implemented in the transponder tag.

The communication method of the present invention is according to an advantageous embodiment a method of sensing the optimum tuning
by sensing the output from the circuit arrangement, in particular from the resonant circuit, and
by varying the controlled resistance

in order to achieve the optimum value of output, wherein this method is applied to a transponder, for instance, in an access card system.

The present invention further relates to a base station for an electronic communication system as described above, wherein the base station is designed for providing the transponder station with electromagnetic radiation in form of power comprising a particular carrier frequency.

Moreover, the present invention relates to a transponder station for an electronic communication system as described above, wherein the controller unit is designed for adapting the receiving frequency to the carrier frequency defined by the base station in such a way that the receiving frequency substantially or approximately equals the carrier frequency.

The present invention finally relates to the use of at least one electronic communication system as described above, in particular
of at least one base station as described above, which base station can be arranged in particular on or in an object to be secured against unauthorized use and/or against unauthorized access, such as on or in a transport means or on or in an access system, and
of at least one transponder station as described above, which transponder station can be carried with him or with her by an authorized user,

and/or of the method as described above
for determining the authorization for use and/or for access by means of the data signals being exchanged between the base station and the transponder station, the data signals being designed
for controlling the base station, and/or
for authenticating and/or for identifying and/or for checking the authority to use, to access, to enter or the like an object to be secured, for example a transport means and/or an access system, and/or
for transponder based or chip card based systems, which in spite of high tolerances of the components of the circuit arrangement require a defined and stable resonant frequency in order to achieve maximum range of bidirectional communication, in particular for access systems, in automotive and non-automotive applications, for example for electronic immobilizer systems for vehicles.

As already discussed above, there are several options to embody as well as to improve the teaching of the present invention in an advantageous manner. To this aim, reference is made to the claims respectively dependent on claim 1 and on claim 7; further improvements, features and advantages of the present invention are explained below in more detail with reference to two preferred embodiments by way of example and to the accompanying drawings where

FIG. 1 schematically shows an electrical circuit diagram of the principle of communication, based on inductive coupling, between a base station and an associated transponder station as prior art embodiment;

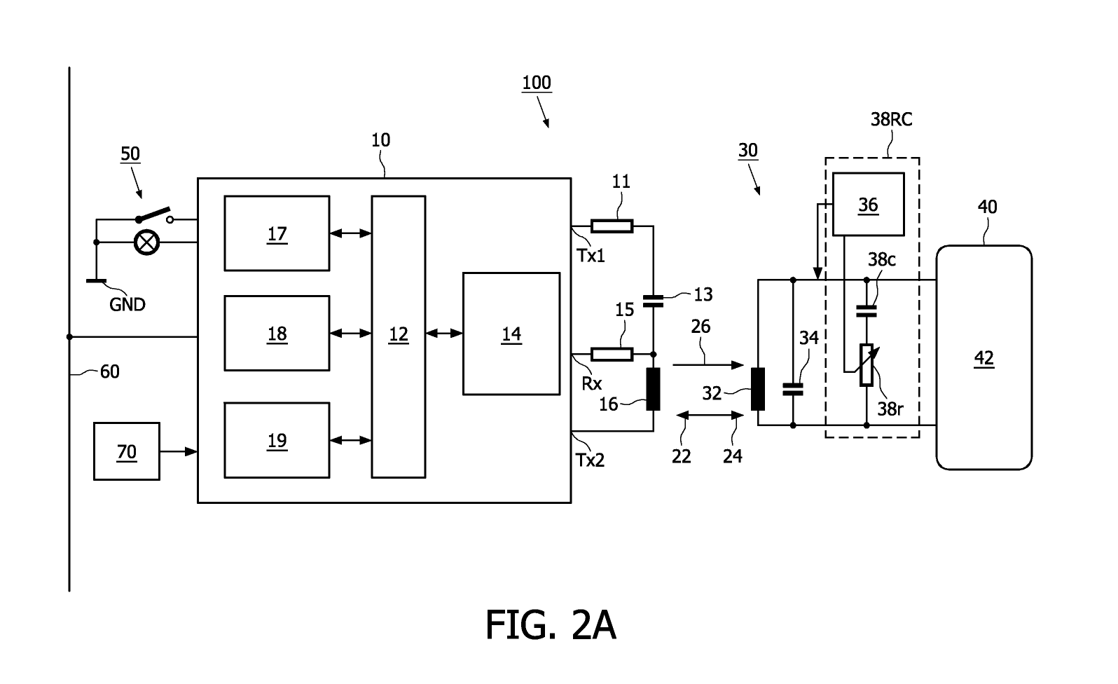

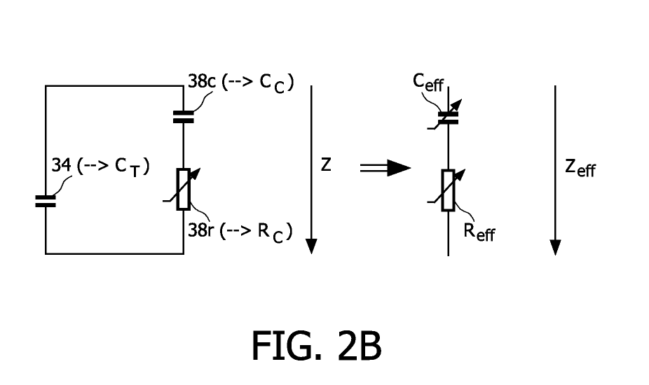

FIG. 2A schematically shows an electrical circuit diagram of a first embodiment of the communication system according to the present invention working according to the method of the present invention;

FIG. 2B schematically shows the principle of calculating the working-point of the communication system of FIG. 2A; and

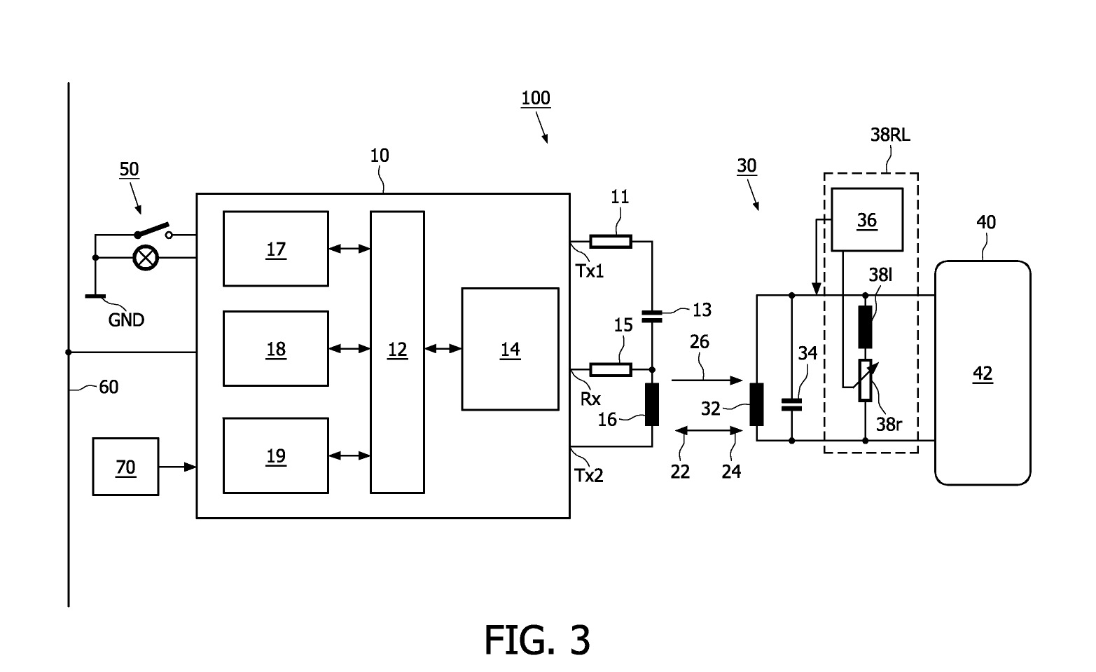

FIG. 3 schematically shows an electrical circuit diagram of a second embodiment of the communication system according to the present invention working according to the method of the present invention.

The same reference numerals are used for corresponding parts in FIGS. 1 to 3.

In order to avoid unnecessary repetitions, the following description regarding the embodiments, characteristics and advantages of the present invention relates (unless stated otherwise)
to the first embodiment of the electronic communication system 100 according to the present invention (cf. FIGS. 2A, 2B) as well as
to the second embodiment of the electronic communication system 100 according to the present invention (cf. FIG. 3),

all embodiments 100 of the present invention being operated according to the method of the present invention.

As shown in FIGS. 2A, 3 an embodiment being implemented by means of the present invention as an electronic communication system 100 comprises, amongst other things, a transponder station or tag unit 40 in form of a data carrier which in turn is part of an immobilizer, in particular of a system for opening and closing the door locks of a motor vehicle. Said electronic communication system 100 is an authentication control system, further comprising a base station 10 being arranged in the motor vehicle.

In FIGS. 2A, 3 a typical system configuration of the electronic communication system 100 is depicted. The base station comprises
a functioning unit 17 implementing I[nput]/O[utput] functions for switching on and for switching off, being connected to an I[nput]/O[utput] 50,
an interface driver unit 18 being connected to a bus system 60, namely to a data bus, and
a voltage regulator unit 19 being connected to a power supply 70, namely to a direct current supply or to a direct voltage supply with ground potential GND as reference.

The functioning unit 17, the interface driver 18 and the voltage regulator 19 are exchanging signals with a control unit 12, namely with a microcontroller unit, of the base station 10. The microcontroller 12 in turn is connected to an I[ntegrated]C[ircuit] 14 of the base station 10.

For receiving and transmitting signals 22, 24, 26, the base station 10 comprises
a first resistor unit 11, namely a transmission resistor, being connected to the base station 10 via a first transmission interface or first transmission terminal Tx1,
a capacitive unit 13, namely a condenser unit, being connected in series with the first resistor unit 11,
a second resistor unit 15, namely a receiving resistor,
being connected to the base station 10 via a receiving interface or receiving terminal Rx and
being connected in parallel to the first resistor unit 11 and to the capacitive unit 13, and
an antenna unit 16, namely an inductive element, for example in coil form,
being connected to the base station 10 via a second transmission interface or second transmission terminal Tx2 and
being connected in parallel to the second resistor unit 15.

For receiving and transmitting signals 22, 24, 26, the transponder station 40 comprises a circuit arrangement 30, namely a receiving oscillator circuit, more specifically a resonant LC circuit, with an antenna unit 32, namely an inductive element, and with a capacitive element 34, namely a condenser unit.

Beside the resonant LC circuit 30, the transponder station 40 comprises an integrated circuit 42, namely a microcontroller unit.

The transponder station 40 and the base station 10 are designed to exchange data signals 22, 24, in particular cipher bits, in which case by means of the data signals 22, 24 the authentication for use and/or for access can be determined.

As signal transmission links between the base station 10 and the transponder station 40, there are in detail
a so-called down-link frame 24 which is formed, for example, by at least one inductively coupled L[ow]F[requency] channel and over which signals are transmitted from the base station 10 to the transponder station 40, and
a so-called up-link frame 22 which is formed, for example, by at least one L[ow]F[requency] channel and over which signals are transmitted from the transponder station 40 to the base station 10.

Thus, both the down-link frame 24 and the up-link frame 22 each are formed by at least one L[ow]F[requency] channel; thus, the present electronic communication system 100, in particular the passive transponder system, works with L[ow]F[requency]/L[ow]F[requency] data as well as with L[ow]F[requency] energy transmission.

After, for example, a pushbutton in the motor vehicle has been operated, the base station 10, which is spatially and functionally associated with the motor vehicle, begins to generate a signal being referred to as a “challenge” and being transmitted to the transponder station 40 via the down-link frame 24.

The integrated circuit 42 in the transponder station 40 (cf. FIGS. 2A, 3), which is equipped with a microprocessor, then calculates from the challenge, using a cryptographic algorithm and a secret key, a signal sequence being referred to as a “response”. This response signal is then transmitted from the transponder station 40 to the base station 10 via the up-link frame 22.

The base station 10 then compares the response, using an identical crypto-algorithm and an identical secret key. If identity is found, the base station 10 causes the door lock of the motor vehicle to open, i.e. only if, generally by using cryptographic methods, the authentication process recognizes the transponder station 40 as valid, the door lock of the motor vehicle is opened.

Since the transponder station 40 comprises no battery or the like, the transponder station 40 is supplied with energy by the base station 10 via a transmission link 26 by which electromagnetic radiation in form of power, for instance with a carrier frequency of 125 Kilohertz, is transmitted from the base station 10 to the remote device 40.

The resonant circuit 30 of the transponder station 40 transforms the induced voltage with the quality factor Q of its own oscillation performance. The oscillation performance in turn is strongly dependent on the detuning of the resonant circuit 30.

Since components with relatively high tolerances are to be used, the two embodiments as depicted in FIGS. 2A and 3 comprise a further controller unit 36 for continuous and/or linear and/or steady controlling of the resonance frequency f of the oscillator circuit 30 of the transponder station 40.

In addition to the components as described above, the first embodiment (cf. FIG. 2A) of the present invention comprises a RC controller member (=reference numeral 38RC) with
a further capacitive element 38c and
a resistor element 38r being controllable by the further controller unit 36.

In contrast thereto, the second embodiment (cf. FIG. 3) of the present invention comprises a RL controller member (=reference numeral 38RL) with
a further inductive element 38l and
a resistor element 38r being controllable by the further controller unit 36.

The controller member 38RC or 38RL can optionally be integrated on the integrated circuit 42 of the transponder 40 or arranged separately; in the latter case, this controller member 38RC or 38RL may be connected between the oscillator circuit 30 and the integrated circuit 42.

The respective methods according to which the first embodiment (cf. FIG. 2A) and the second embodiment (cf. FIG. 3) work perform with simple circuitry means 36, 38c, 38r or 36, 38l, 38r a controlling of the receiving frequency f, namely of the resonance frequency, of the transponder station 40 to its optimum.

This optimum provides the maximal voltage at the oscillator circuit 30 of the transponder 40 at a predetermined constant carrier frequency and generates therewith optimal conditions for electrical transmission 26 and for data transmission 22, 24.

The use of such additional actuating member or controlling element, such as
the capacity 38c comprising a capacitance C_{C} being connected in series with the controllable resistor 38r comprising a resistance R_{C} (cf. FIG. 2A) or
the inductivity 38l comprising an inductance being connected in series with the controllable resistor 38r comprising a resistance R_{C} (cf. FIG. 3), and

the use of the electrical controller unit 36 enable the control of the resonance frequency f of the LC circuitry 30 (comprising the antenna unit 32 and the condenser unit 34) of the transponder station 40 to the optimum, i.e. to the carrier frequency (=125 Kilohertz in the exemplary embodiments of FIGS. 2A, 3).

To adjust or update the actual resonance frequency f of the oscillator circuitry 30 of the transponder station 40, the value of the electrically controllable resistor unit 38r can be modified until the maximum of the voltage of the oscillator circuitry 30 is achieved (in resonance with the carrier frequency). Thereupon the value of the electrically controllable resistor unit 38r is maintained or frozen because the operating point or working point is reached.

The described algorithm can be repeated arbitrarily, but advantageously a non-modulated carrier is applied to avoid control-failures and instabilities.

The operating point or working point of the controller unit 36 comprising
adjusted values for the further capacitive element 38c and for the electrically controllable resistor 38r (cf. FIG. 2A), or
adjusted values for the further inductive element 38l and for the electrically controllable resistor 38r (cf. FIG. 3)

can be chosen in such a way that the quality factor Q of the oscillator circuit or resonant circuit 30 neither in the nominal working-point nor close to the nominal working-point is drastically reduced.

Finally, the principle of calculation for determining the working-point is depicted in FIG. 2B:

First, the impedance Z of the circuit comprising
the capacitive element 34 of the transponder station 40 (having a capacitance C_{T} and thus a capacitive reactance or impedance

$$\frac{1}{j ω {C}_{T}} ) ,$$

the further capacitive element 38c of the transponder station 40, (having a capacitance C_{C} and thus a capacitive reactance or impedance

$$\frac{1}{j ω {C}_{C}} ) , and$$

the controllable resistor element 38r of the transponder station 40 (having a resistance R_{C})

is calculated according to the formula

$$\frac{1}{Z} = \frac{1}{\frac{1}{j ω {C}_{T}}} + \frac{1}{\frac{1}{jω {C}_{C}} + {R}_{C}} ,$$

thus resulting in

$$Z = \frac{\frac{1}{jω {C}_{T}} ( \frac{1}{jω {C}_{C}} + {R}_{C} )}{\frac{1}{jω {C}_{T}} + \frac{1}{jω {C}_{C}} + {R}_{C}} ,$$

with ω=2πf, wherein f is the receiving frequency or resonant frequency of the transponder station 40; and

j²=−1.

In the next step (=arrow showing from left part of FIG. 2B to right part of FIG. 2B),
the capacitive element 34 of the transponder station 40 (having a capacitance C_{T} and thus a capacitive reactance or impedance

$$\frac{1}{j ω {C}_{T}} ) ,$$

the further capacitive element 38c of the transponder station 40, (having a capacitance C_{C} and thus a capacitive reactance or impedance

$$\frac{1}{j ω {C}_{C}} ) , and$$

the controllable resistor element 38r of the transponder station 40 (having a resistance R_{C})

are abstracted to
an effective capacitive element of the transponder station 40 (having an effective capacitance C_{eff} and thus an effective capacitive reactance or effective impedance

$$\frac{1}{j ω {C}_{eff}} ) ,$$

and
an effective controllable resistor element of the transponder station 40

(having an effective resistance R_{eff})

The resulting effective impedance Z_{eff} is calculated according to the formula

$${Z}_{eff} = \frac{1}{jω {C}_{eff}} + {R}_{eff} .$$

After comparison of the coefficients, in particular after eliminating the impedance Z with the effective impedance Z_{eff}.
the effective capacitance C_{eff} results in

$${C}_{eff} = {C}_{T} \frac{{( ω {R}_{C} {C}_{T} )}^{2} + {( 1 + \frac{{C}_{T}}{{C}_{C}} )}^{2}}{{( ω {R}_{C} {C}_{T} )}^{2} + ( 1 + \frac{{C}_{T}}{{C}_{C}} ) \frac{{C}_{T}}{{C}_{C}}} , and$$

the effective resistance R_{eff} results in

$${R}_{eff} = {R}_{C} \frac{1}{{( ω {R}_{C} {C}_{T} )}^{2} + {( 1 + \frac{{C}_{T}}{{C}_{C}} )}^{2}} .$$

### LIST OF REFERENCE NUMERALS

100 electronic communication system, in particular authentication control system
10 base station
11 first resistor unit, in particular transmission resistor, of base station 10
12 control unit, in particular microcontroller unit, of base station 10
13 capacitive unit of base station 10
14 integrated circuit, in particular with analog interface, of base station 10
15 second resistor unit, in particular receiving resistor, of base station 10
16 antenna unit, in particular inductive element, for example in coil form, of base station 10
17 functioning unit, in particular I[nput]/O[utput] functions for switching on and for switching off, of base station 10
18 interface driver unit of base station 10
19 voltage regulator unit of base station 10
22 data signal, in particular up-link of bidirectional communication, being sent by transponder station 40
24 data signal, in particular down-link of bidirectional communication, being sent by base station 10
26 electromagnetic radiation in form of power being sent by base station 10, for example with carrier frequency of 125 Kilohertz
30 circuit arrangement, in particular receiving oscillator circuit, for example resonant LC circuit, of transponder station 40
32 antenna unit, in particular inductive element, of transponder station 40
34 capacitive element, in particular condenser unit, of transponder station 40
36 controller unit, in particular microcontroller unit, of transponder station 40
38c further capacitive element, in particular further condenser unit, of transponder station 40
38l further inductive element, in particular further coil unit, of transponder station 40
38r controllable resistor element of transponder station 40
38RC RC controller member comprising further controller unit 36, capacitive element 38c and controllable resistor element 38r
38RL RL controller member comprising further controller unit 36, inductive element 38l and controllable resistor element 38r
40 transponder station, in particular data carrier, for example passive transponder
42 integrated circuit, in particular microcontroller unit, of transponder station 40
50 I[nput]/O[utput] switch unit of base station 10
60 bus system, in particular data bus, connected to base station 10
70 power supply, in particular direct current supply or direct voltage supply, of base station 10
C_{C} capacitance or capacity of further capacitive element 38c
C_{eff} effective capacitance or effective capacity resulting from capacitance or capacity C_{T} of capacitive element 34 and from capacitance or capacity C_{C} of further capacitive element 38c
C_{T} capacitance or capacity of capacitive element 34
f receiving frequency, in particular resonant frequency
GND ground potential, in particular earth potential
R_{C} resistance of controllable resistor element 38r
R_{eff} effective resistance resulting from impedance, in particular from capacitive reactance,

$$\frac{1}{jω {C}_{T}}$$

of capacitive element 34, from impedance, in particular from capacitive reactance,

$$\frac{1}{jω {C}_{C}}$$

of further capacitive element 38c and from resistance R_{C} of controllable resistor element 38r
Rx receiving interface, in particular receiving terminal, of base station 10
Tx1 first transmission interface, in particular first transmission terminal, of base station 10
Tx2 second transmission interface, in particular second transmission terminal, of base station 10
Z impedance resulting impedance, in particular from capacitive reactance,

$$\frac{1}{jω {C}_{T}}$$

of capacitive element 34, from impedance, in particular from capacitive reactance,

$$\frac{1}{jω {C}_{C}}$$

of further capacitive element 38c and from resistance R_{C} of controllable resistor element 38r
Z_{eff} impedance resulting from effective capacitance or effective capacity C_{eff} and from effective resistance R_{eff}

1. An electronic communication system, having
at least one base station with at least one antenna unit, in particular in coil form; and
at least one transponder station, in particular in data carrier form, with at least one antenna unit, in particular in coil form,
for receiving electromagnetic radiation in form of power to be supplied by the base station with a particular carrier frequency and
for exchanging data signals with the base station,
characterized by at least one controller unit for controlling the receiving frequency of the antenna unit of the transponder station during operation of the communication system, in particular for adapting the resonant frequency of the antenna unit of the transponder station to the carrier frequency defined by the base.

2. The electronic communication system according to claim 1, characterized in that the receiving frequency is controlled in a continuous and/or linear and/or steady mode.

3. The electronic communication system according to claim 1, characterized in that the receiving frequency is defined by at least one circuit arrangement, in particular by at least one receiving oscillator circuit, for example by at least one resonant LC circuit, which circuit arrangement is assigned to the transponder station and comprises
at least one capacitive element, being in particular connected in parallel to the antenna unit of the transponder station, and
at least one resistor element, wherein
the resistance value of the resistor element is controllable by the controller unit and/or
the resistor element is connected in parallel to the capacitive element and/or to the antenna unit of the transponder station.

4. The electronic communication system according to claim 3, characterized in that the resistor element is serially connected
to at least one further capacitive element, in particular to at least one condenser unit, being controllable by the controller unit or
to at least one further inductive element, in particular to at least one coil unit, being controllable by the controller unit.

5. A base station for an electronic communication system according to claim 1,
characterized by being designed for providing the transponder station with electromagnetic radiation in form of power comprising a particular carrier frequency.

6. A transponder station for an electronic communication system according to at least one of claim 1,
characterized by the controller unit being designed for adapting the receiving frequency to the carrier frequency defined by the base station in such a way that the receiving frequency substantially or approximately equals the carrier frequency.

7. A communication method
for providing at least one transponder station, in particular at least one data carrier, with electromagnetic radiation in form of power to be supplied by at least one base station with a particular carrier frequency and
for exchanging data signals within an electronic communication system, in particular according to the preamble of claim 1,
characterized in that the receiving frequency of the transponder station is controlled during operation of the communication system, in particular that the resonant frequency of the transponder station is adapted to the carrier frequency defined by the base station.

8. The method according to claim 7, characterized in that the receiving frequency is controlled in a continuous and/or linear and/or steady mode.

9. The method according to claim 7, characterized in that the receiving frequency is adapted to the carrier frequency in such a way that the receiving frequency substantially or approximately equals the carrier frequency.

10. Use of at least one electronic communication system according to claim 1,
of at least one base station, said base station can be arranged in particular on or in an object to be secured against unauthorized use and/or against unauthorized access, such as on or in a transport means or on or in an access system, and
of at least one transponder station, said transponder station can be carried with him or her by an authorized user, and/or of the method
for determining the authorization for use and/or for access by means of the data signals being exchanged between the base station and the transponder station, the data signals being designed
for controlling the base station, and/or
for authenticating and/or for identifying and/or for checking the authority to use, to access, to enter or the like an object to be secured, for example a transport means and/or an access system, and/or
for transponder based or chip card based systems, which in spite of high tolerances of the components of the circuit arrangement require a defined and stable resonant frequency in order to achieve maximum range of bidirectional communication, in particular for access systems, in automotive and non-automotive applications, for example for electronic immobilizer systems for vehicles.
